(19) United States
(12) Patent Application Publication
(10) Pub. No.: US 2011/0118901 A1
(43) Pub. Date: May 19, 2011

(54) Device for Securing a Flight Sequence of an Unmanned Aircraft

(75) Inventors: Rémi GEOFFROY, Saint Medard en Jalles (FR); Yannick THIRY, Biganos (FR); Patrick CAZAUX, Le Pian Medoc (FR)

(73) Assignee: THALES, Neuilly-sur-Seine (FR)

(21) Appl. No.: 12/945,690

(22) Filed: Nov. 12, 2010

(30) Foreign Application Priority Data
Nov. 13, 2009 (FR) 09 05469

(51) Int. Cl. G05D 1/00

(52) U.S. Cl. 701/2

(57) ABSTRACT

A device for assisting in the decking of an aircraft, the aircraft being remotely controlled from a mobile station, called a ship, includes means of receiving data originating from the aircraft, notably attitudes of the aircraft and its altitude, the aircraft being in stationary flight ready to deck, a first coordinate system being defined relative to the aircraft, a second coordinate system being defined relative to the ship. The device for assisting in the decking of an aircraft includes a display for generating the position of the aircraft in a coordinate system linked to the ship in a first vertical representation and in a second horizontal representation.

### CROSS-REFERENCE TO RELATED APPLICATION

This application claims priority to foreign French patent application No. FR 0905469, filed on Nov. 13, 2009, the disclosure of which is incorporated by reference in its entirety.

### FIELD OF THE INVENTION

The present invention relates to the field of the generation of data in a display intended to monitor the correct operation of an aircraft flight sequence. More particularly, the field of the invention is that of the remote control devices intended to supervise an unmanned aircraft. Finally, the field relates to the devices for assisting in the decking of an aircraft on a mobile vehicle. The invention relates notably to the image generation devices used to display data and symbols for following and securing a flight sequence of an aircraft.

### BACKGROUND OF THE INVENTION

Currently, in aircraft decking manoeuvres partly remotely controlled by an operator on a ship, it is necessary for the operator to have means to supervise its movement during a mission.

Notably, the supervision of certain manoeuvres makes it possible to guarantee safety for the equipment and for the crew. These manoeuvres generally involve critical flight phases such as take-off or decking.

Currently, some systems enable an operator to control the behaviour of an aircraft in critical phases and to take decisions as and when required. In particular, during take-off and decking phases, the operator must be responsive. In the event of incidents, the mission must be quickly interrupted in order to firstly secure the onboard personnel and secondly secure the craft.

These existing systems can be used to follow the movements and ensure that the trajectory of the aircraft is correctly followed within a terrestrial frame of reference.

One drawback to these solutions is that the aircraft moves in a coordinate system that is linked to the ship from the point of view of the operator. Now, the operator can control and supervise the movements of the aircraft, but in a terrestrial coordinate system, and must use another supervision means to anticipate the movements of the ship.

So as to ensure that safety is maximized during critical flight phases such as take-off or decking, information originating from two systems with different dynamics must then be permanently supervised. The operator is therefore obliged to devote most of his attention to following the movements of the ship and of the aircraft.

Currently, some devices make it possible to represent a coordinate system in longitudinal cross section and a coordinate system in vertical cross section in order to control the changes in position of the aircraft on three axes.

Each of these two coordinate systems can be likened to a terrestrial coordinate system, which means that the origin of each of these coordinate systems is a fixed point of the earth and its axes are linked to the earth's rotation.

One drawback to this solution is that it is difficult for an operator to supervise the movements of the aircraft relative to a mobile origin when the latter is represented in a terrestrial coordinate system.

Notably, it is difficult to supervise the positions and the movement trends of the aircraft relative to a mobile origin, as is the case in the context of the invention which relates to the decking of an aircraft on a ship.

With the prior art solutions, if the aircraft is in stationary flight, it is fixed in the coordinate system. This solution does not therefore enable the operator to observe the dynamics of the ship which do, however, greatly influence the decision to cancel or continue with a decking for example.

### SUMMARY OF THE INVENTION

The invention overcomes the abovementioned drawbacks.

The invention makes it possible to generate a representation of the aircraft and its movements while taking into account the movements of the ship. From a single representation according to two coordinate systems, respectively vertical and horizontal, the invention makes it possible to control the movements of the aircraft in a context in which the ship is moving, that is to say, in a mobile coordinate system in the terrestrial frame of reference.

Advantageously, the device for assisting in the decking of an aircraft, the aircraft being remotely controlled from a mobile station, called a ship, comprises means of receiving data originating from the aircraft, notably attitudes of the aircraft and its altitude, the aircraft being in stationary flight ready to deck, a first frame of reference (0, X, Y, Z) being defined relative to the ship.

Advantageously, the device comprises a computer for generating the position of the aircraft in a display, the first frame of reference (0, X, Y, Z) having a first coordinate system (0, X, Z) in a vertical plane making it possible to view the vertical movements of the aircraft and a second coordinate system (0, X, Y) in a horizontal plane making it possible to view the lateral movements of the aircraft.

Advantageously, the first coordinate system has for its centre a notable point of the ship and the plane comprising the deck of the ship comprises the horizontal axis (O, X) of the first coordinate system (0, X, Z).

Advantageously, the second coordinate system (0, X, Y) has for its centre a notable point of the ship.

Advantageously, a safety area and a decking grid (6) are represented on the second coordinate system (0, X, Y).

Advantageously, the deck of the ship is represented on the second coordinate system (0, X, Y).

Advantageously, the computer generates a symbol representing the aircraft on the second coordinate system (0, X, Y), the size of the symbol being a function of the altitude of the aircraft.

Advantageously, the size of the symbol representing the aircraft is a linear function of the altitude of the aircraft.

### BRIEF DESCRIPTION OF THE DRAWINGS

Other features and advantages of the invention will become apparent from the following description, given with reference to the appended drawings which represent:

FIG. 1: an aircraft and its trajectory in a mobile coordinate system linked to a ship on which the aircraft is ready to deck;

FIG. 2: an aircraft and its trajectory in a mobile coordinate system linked to a ship on which the aircraft is close to the deck of the ship.

### DETAILED DESCRIPTION

The invention makes it possible to generate a representation of the aircraft in a first frame of reference linked to a mobile vehicle designed to serve as a landing or decking platform. The mobile vehicle is moving in a terrestrial frame of reference.

In a preferred embodiment of the invention, the mobile vehicle is a ship.

Hereinafter in the description, the frame of reference linked to the ship will be called the first frame of reference and the frame of reference linked to the earth will be called the terrestrial frame of reference.

The inventive solution involves defining two representations of the first frame of reference each including a 2D coordinate system whose mobile origin is a point of the ship. A first 2D representation of the first frame of reference comprises a vertical plane (O, X, Z), a second 2D representation of the first frame of reference comprises a horizontal plane (O, X, Y).

Preferably, the origin of the first frame of reference can be chosen to be the centre of the decking grid of the ship or any other notable point of the ship.

The generation of the first coordinate system in vertical cross section enables an operator to follow the positions and the movements of an aircraft getting ready to deck on the ship. The aircraft follows a trajectory and has a first absolute current altitude. Given the variations in altitude of the ship caused by the swell, the first coordinate system is used to ascertain, at each instant, the altitude of the aircraft relative to the ship.

When the aircraft is in stationary flight, the operator can view the vertical movements induced by the dynamics of the ship.

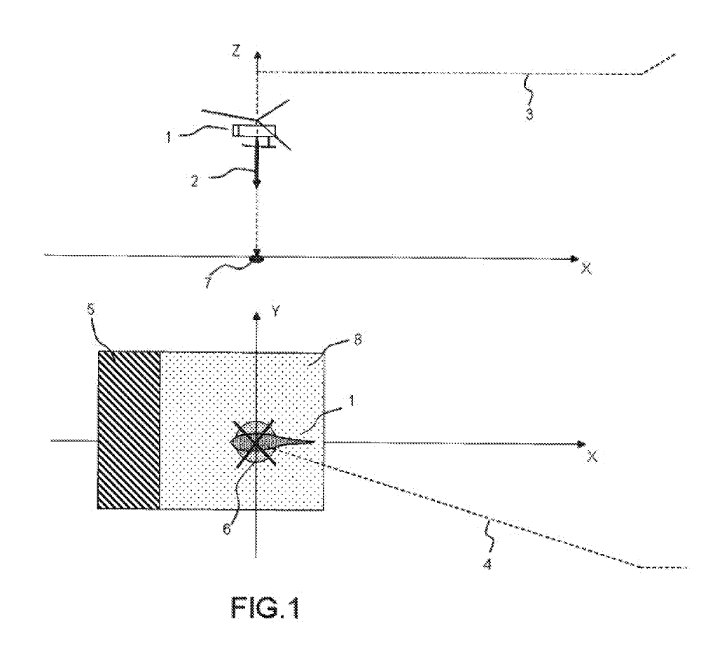

FIG. 1 represents an embodiment of the invention comprising a first representation of the aircraft 1 in the process of carrying out a decking procedure on a ship in which the horizontal axis of the deck coincides with the axis X. A target point 7, situated on the deck of the ship, is the desired final stopping point for the trajectory of the aircraft in its decking procedure, which can be chosen in one embodiment to be the origin of the coordinate system. In FIG. 1, the aircraft 1 is following a vertical trajectory 3 and has a vertical descent speed 2 along the axis Z.

FIG. 1 shows a second representation of the aircraft 1 in its decking procedure according to an equatorial cross section.

In the same way as for the first coordinate system, this second coordinate system offers the possibility of viewing the movements of the aircraft relative to the movements of the ship.

This second coordinate system in equatorial cross section, that is to say seen from above, enables the operator to follow the positions and the movements of the aircraft 1 in terms of latitude and longitude. Notably, this second coordinate system makes it possible to generate the horizontal trajectory 4 of the aircraft 1.

On the second coordinate system, the invention makes it possible to generate certain decking aid indications for the operator who is controlling the decking from the ship.

Notably, the position of the deck, the position of a safety area and the position of a decking grid can be generated so as to be represented on the second coordinate system.

The invention makes it possible to define a predefined geometry for the elements located on the ship. Notably, the sizes of the symbols representing the deck 8, the safety area 5 and the decking grid 6 can be defined in an initialization step for the inventive device.

The invention makes it possible to generate a variable size of the symbol representing the aircraft on the second coordinate system, the elements linked to the ship being of fixed size. A preferred embodiment of the invention makes it possible to vary the size of the symbol representing the aircraft according to its altitude. For example, a linear law between the size of the aircraft and its altitude can be applied.

The law linking the size of the symbol and the altitude of the aircraft makes it possible to generate a zoom function when displaying the symbol of the aircraft in the horizontal plane. The zoom enables an operator to assess the altitude of the aircraft above the deck for example.

The invention therefore makes it possible to generate two representations of the aircraft in two 2D coordinate systems, respectively vertical and horizontal, so as to supervise and control the correct aircraft decking procedure. Furthermore, the invention enables the operator to focus mainly on the movements of the aircraft relative to the ship.

The invention makes it possible to generate a representation of the dynamics of the aircraft and of the ship in vertical and horizontal planes in order to assist the operator in taking decisions. The operator therefore no longer needs to independently follow the movements of the ship.

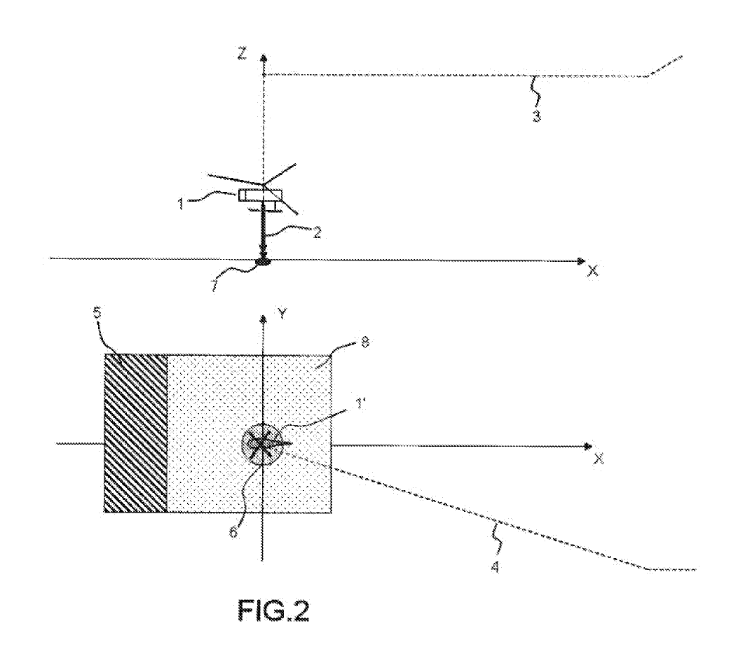

FIG. 2 represents the first and second coordinate systems in a context in which the aircraft is close to the deck 8 of the ship. The decking procedure is the same as that of FIG. 1, the aircraft having performed a vertical descent movement.

The invention makes it possible to reduce the size of the symbol 1′ representing the aircraft, whereas the symbols representing certain elements of the ship are unchanged in size.

This variation in the size of the symbol 1′, representing the aircraft, on the horizontal cross-sectional view, makes it possible to follow the movements altitude-wise of the aircraft. This variation makes it possible to add, for the operator, an indicator 20 as to the position of the aircraft on this representation so as to secure the decking manoeuvre.

According to a preferred embodiment of the invention, the size variation of the symbol representing the aircraft varies linearly with the altitude variation. It offers an operator the advantage of checking that the aircraft decks correctly on the decking grid and, if not, of providing corrective measures to restore the aircraft to its decking trajectory.

Furthermore, this representation improves awareness of the situation and improves the assessment of a potential hazard arising during the manoeuvre.

One advantage of the invention is that the operator no longer has to worry about the movements of the ship and take them into account in order to assess the situation of the aircraft in its approach. The operator can directly interpret the situation of the aircraft within a frame of reference linked to the ship, the frame of reference taking into account the dynamics of the ship.

Advantageously, the invention enables an operator responsible for checking that the decking proceeds correctly to follow the changes and the movements of the aircraft in a decking mission on a ship having its own dynamics.

The invention makes it possible to:
define a coordinate system that makes it possible to follow the vertical changes of the aircraft in a mobile frame of reference linked to the ship centred on a point of the decking grid;
define a coordinate system making it possible to follow the horizontal changes of the aircraft in this same mobile frame of reference;
display a symbol representing the aircraft and representing its relative position in each of the coordinate systems;
vary the size of the symbol, in the horizontal cross section, in order to represent the altitude variations of the aircraft consistently with the vertical cross-sectional view.

In variant embodiments, the mobile vehicle may be a lorry or a train.

What is claimed is:

1. A device for assisting in the decking of an aircraft, the aircraft being remotely controlled from a mobile station, called a ship, comprising:
means of receiving data originating from the aircraft, notably the attitudes of the aircraft and its altitude, the aircraft being in stationary flight ready to deck, a first frame of reference being defined relative to the ship, and
a computer for generating the position of the aircraft in a display, the first frame of reference having a first coordinate system in a vertical plane making it possible to view the vertical movements of the aircraft and a second coordinate system in a horizontal plane making it possible to view the lateral movements of the aircraft.

2. A device for assisting in the decking of an aircraft according to claim 1, wherein the first coordinate system has for its centre a notable point of the ship and that the plane comprising the deck of the ship comprises a horizontal axis of the first coordinate system.

3. A device for assisting in the decking of an aircraft according to claim 2, wherein the second coordinate system has for its centre a notable point of the ship.

4. A device for assisting in the decking of an aircraft according to claim 3, wherein a safety area and a decking grid are represented on the second coordinate system.

5. A device for assisting in the decking of an aircraft according to claim 3, wherein the deck of the ship is represented on the second coordinate system.

6. A device for assisting in the decking of an aircraft according to claim 3, wherein the computer generates a symbol representing the aircraft on the second coordinate system, the size of the symbol being a function of the altitude of the aircraft.

7. A device for assisting in the decking of an aircraft according to claim 6, wherein the size of the symbol representing the aircraft is a linear function of the altitude of the aircraft.
